(19) United States
(12) Patent Application Publication
(10) Pub. No.: US 2026/0348573 A1
(43) Pub. Date: Nov. 5, 2026

(54) LIGHTING FIXTURE

(71) Applicants: SUZHOU OPPLE LIGHTING CO., LTD., Suzhou City (CN); OPPLE LIGHTING CO., LTD., Shanghai (CN)

(72) Inventor: Yong ZHAN, Suzhou City (CN)

(73) Assignees: SUZHOU OPPLE LIGHTING CO., LTD., Suzhou City (CN); OPPLE LIGHTING CO., LTD., Shanghai (CN)

(21) Appl. No.: 19/719,128

(22) Filed: Jun. 24, 2026

Related U.S. Application Data
(63) Continuation of application No. PCT/CN2024/140943, filed on Dec. 20, 2024.

(30) Foreign Application Priority Data
Dec. 25, 2023 (CN) 202323537202.3

(51) Int. Cl. F21V 29/70; F21V 17/12; F21V 19/00

(52) U.S. Cl. CPC F21V 29/70; F21V 17/12; F21V 19/0045; F21V 19/005

(57) ABSTRACT

A lighting fixture includes a housing and a photoelectric assembly accommodated within the housing. The housing includes a bottom wall, side walls extending from the bottom wall, a boss protruding toward the photoelectric assembly, and an annular groove formed between the boss and the side walls. When mounted within the housing, a first portion of the photoelectric assembly abuts against the boss, and a second portion of the photoelectric assembly extends over the annular groove and is spaced from the housing by a gap. The boss provides a heat dissipation path for the photoelectric assembly, while the gap increases electrical distance and creepage distance between the photoelectric assembly and the housing.

### CROSS-REFERENCE TO RELATED APPLICATION

This disclosure is based upon and claims the priority of PCT patent disclosure No. PCT/CN2024/140943 filed on Dec. 20, 2024, which claims priority to the Chinese patent disclosure No. 202323537202.3 filed on Dec. 25, 2023, the entire contents of which are hereby incorporated by reference herein for all purposes.

### TECHNICAL FIELD

The present disclosure relates to a lighting fixture, falling within the technical field of illumination.

### BACKGROUND

Some downlights require additional heat dissipation structures, which increase the overall height of the downlight and impose stringent requirements on installation environments.

### SUMMARY

The present disclosure provides a lighting fixture including a housing and a photoelectric assembly accommodated within the housing.

Accordingly, the housing includes a bottom wall facing the photoelectric assembly and side walls extending downward from an outer peripheral edge of the bottom wall. A boss protruding toward the photoelectric assembly is arranged on the bottom wall, and an annular groove is formed between the boss and the side walls. When the photoelectric assembly is mounted within the housing, a portion of the photoelectric assembly abuts against the boss, while another portion extends to overhang below the annular groove, with a gap provided between the other portion of the photoelectric assembly and the annular groove along an extension direction of the side walls.

It is to be understood that both the foregoing general description and the following detailed description are exemplary and explanatory only and are not restrictive of the present disclosure.

### BRIEF DESCRIPTION OF DRAWINGS

FIG. 1 is a schematic structural diagram of a lighting fixture according to the present disclosure;

FIG. 2 is an exploded view of the lighting fixture shown in FIG. 1;

FIG. 3 is a schematic structural diagram of the housing shown in FIG. 2;

FIG. 4 is an assembly diagram of a photoelectric assembly, an electric wire and a cable gland shown in FIG. 2;

FIG. 5 is a schematic structural diagram of a trim ring shown in FIG. 2;

FIG. 6 is a schematic structural diagram of a reflector shown in FIG. 2;

FIG. 7 is a cross-sectional view of the lighting fixture shown in FIG. 1; and

FIG. 8 is an enlarged view of a circled area in FIG. 7.

### DETAILED DESCRIPTION

To make the objectives, technical solutions and advantages of the present disclosure clearer, the present disclosure will be described in detail below with reference to the accompanying drawings and examples.

It should be noted that to avoid obscuring the present disclosure with unnecessary details, only structures and/or processing steps closely related to the solution of the present disclosure are shown in the accompanying drawings, while other details irrelevant to the present disclosure are omitted.

It should also be noted that the terms “include”, “comprise” or any variants thereof are intended to cover non-exclusive inclusion, such that a process, method, article or device including a series of elements includes not only those elements but also other elements not explicitly listed, or elements inherent to such process, method, article or device.

Some downlights require additional heat dissipation structures, which increase the overall height of the downlight and impose stringent requirements on installation environments. Conversely, simply reducing the height of the downlight fails to meet safety standard specifications and poses potential safety hazards.

In view of the foregoing drawbacks, there is a need to improve existing lighting fixtures to resolve the above problems.

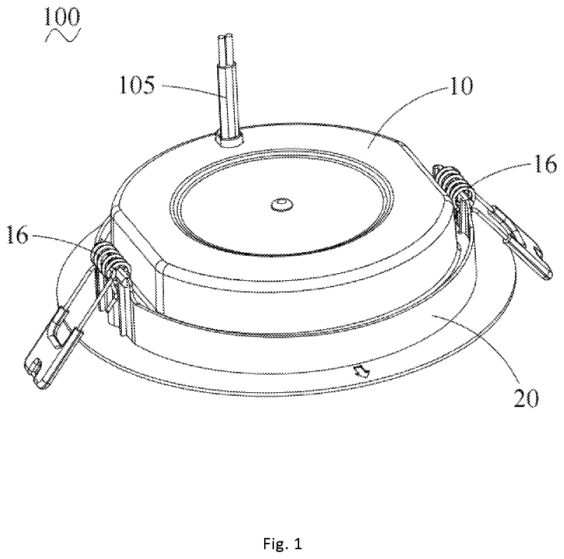

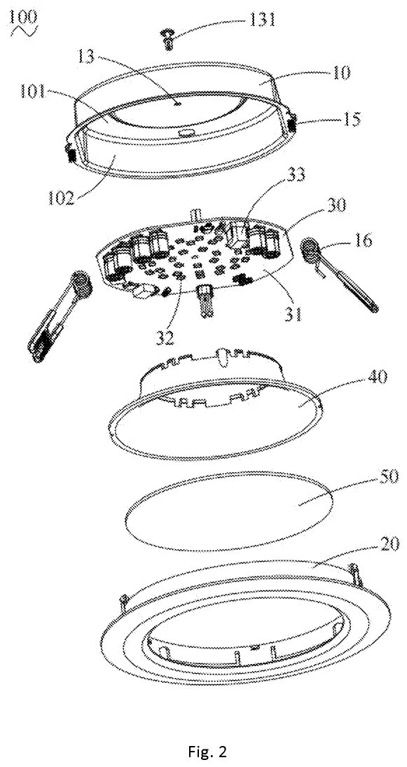

As shown in FIG. 1 and FIG. 2, the present disclosure discloses a lighting fixture 100, preferably a downlight, which includes a housing 10 and a trim ring 20 arranged at an opening of the housing 10. Elastic members 16 are arranged on the outer side of the trim ring 20, preferably a pair of torsion springs, for mounting and fixing the lighting fixture 100.

The lighting fixture 100 further includes a photoelectric assembly 30 and a reflector 40 disposed between the housing 10 and the trim ring 20. The photoelectric assembly 30 is accommodated inside the housing 10 and configured to emit light, and the light is converged by the reflector 40 before exiting through the trim ring 20.

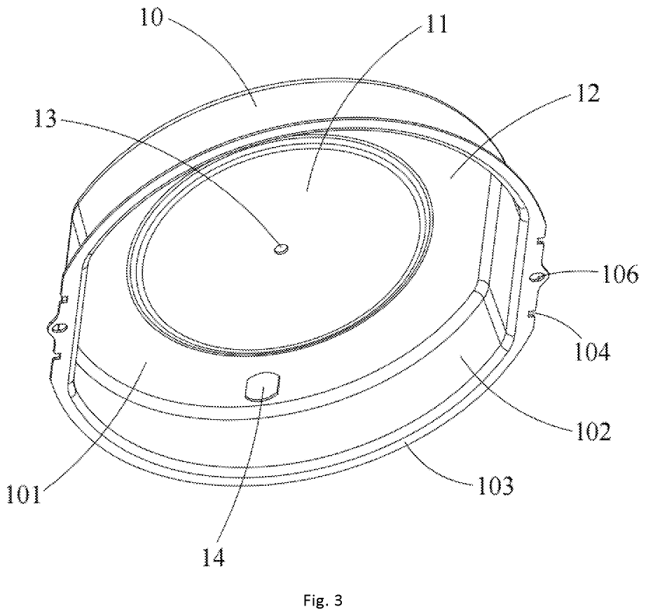

With reference to FIG. 3, the housing 10 is provided with a bottom wall 101 facing the photoelectric assembly 30 and side walls 102 extending vertically downward from the outer peripheral edge of the bottom wall 101, and the side walls 102 surround the bottom wall 101. A boss 11 protruding toward the photoelectric assembly 30 is arranged on the bottom wall 101, and an annular groove 12 is formed between the boss 11 and the side walls 102. When the photoelectric assembly 30 is mounted inside the housing 10, a part of the photoelectric assembly abuts against the boss 11, and the other part of the photoelectric assembly extends to overhang below the annular groove 12, with a gap reserved between the other part of the photoelectric assembly 30 and the annular groove 12 in the vertical direction (i.e., the extension direction of the side walls 102). The reserved gap enlarges the electrical distance and creepage distance between the housing 10 and the photoelectric assembly 30, which allows the lighting fixture 100 to meet safety standard specifications while reducing its overall height, thus effectively protecting end users'safety. Preferably, the gap is greater than 1 mm.

A first mounting hole 13 is formed on the boss 11, and the photoelectric assembly 30 is fixed to the housing 10 by a first fastener 131 passing through the first mounting hole 13. Specifically, the first fastener 131 is arranged inside the first mounting hole 13 and penetrates both the boss 11 and the photoelectric assembly 30 to fix the boss 11 to the photoelectric assembly 30 while bringing the boss 11 into tight contact with the photoelectric assembly 30, so that the photoelectric assembly 30 can dissipate heat through the housing 10.

The photoelectric assembly 30 includes a substrate 31, a light source module 32 and a power supply module 33. The first fastener 131 is configured to fix the boss 11 and the substrate 31. The power supply module 33 is configured to supply power to the light source module 32, which includes a plurality of LED units arranged in an array to provide illumination. Both the light source module 32 and the power supply module 33 are integrated on the substrate 31, and the power supply module 33 is arranged to surround the light source module 32 and is positioned radially outside the light source module 32.

It can be understood that the housing 10 is made of a metal material, preferably a metal heat-dissipating housing. Optionally, heat sinks may be additionally arranged on the outer side of the housing 10 to further improve heat dissipation performance. In addition, to guarantee electrical safety, the first fastener 131 is a plastic rivet; the trim ring 20 and the reflector 40 are both plastic parts; and the substrate 31 is made of FR-4 insulating material to avoid electrical conduction with the housing 10.

Furthermore, the substrate 31 extends, along a radial direction of the housing 10, to the outer periphery of the boss 11, i.e., the diameter of the substrate 31 is larger than that of the boss 11. This arrangement enables a part of the photoelectric assembly 30 to abut against the boss 11 and enables the other part of the photoelectric assembly 30 to extend into the annular groove 12. In particular, since the boss 11 protrudes toward the substrate 31 and is arranged at the central position of the bottom wall 101, the annular groove 12 is formed around the outer periphery of the boss 11, and the substrate 31 extends to be below the annular groove 12, with a gap reserved between the substrate 31 and the annular groove 12.

In this example, the power supply module 33 is arranged on the substrate 31 at a position corresponding to the annular groove 12, and overhangs below the annular groove 12, which can increase the electrical distance and creepage distance between the power supply module 33 and the housing 10. In other words, the orthographic projection of the power supply module 33 on the bottom wall 101 of the housing 10 overlaps with the annular groove 12, and the orthographic projection of the light source module 32 on the bottom wall 101 of the housing 10 overlaps with the boss 11. Meanwhile, the light source module 32 can dissipate heat through the boss 11.

It should be clarified as follows: (i) since the substrate 31 is made of an insulating material, attaching the portion corresponding to the light source module 32 onto the boss 11 can improve the heat dissipation efficiency of the light source module 32; (ii) since the power supply module 33 includes multiple live components and is arranged on the outer periphery of the substrate 31, a gap larger than 1 mm needs to be reserved between the power supply module 33 and the annular groove 12, which widens the spacing between the live components and the housing 10, thereby increasing the electrical distance and creepage distance therebetween and effectively protecting end users'operational safety; in this way, the electrical distance and creepage distance between the live components and the housing 10 comply with safety standard specifications; (iii) integrating the light source module 32 and the power supply module 33 on the substrate 31 forms an integrated photoelectric structure, which effectively reduces the height of the lighting fixture 100 and enables its application in suspended ceilings with low height or in other environments with height restrictions of the lighting fixture.

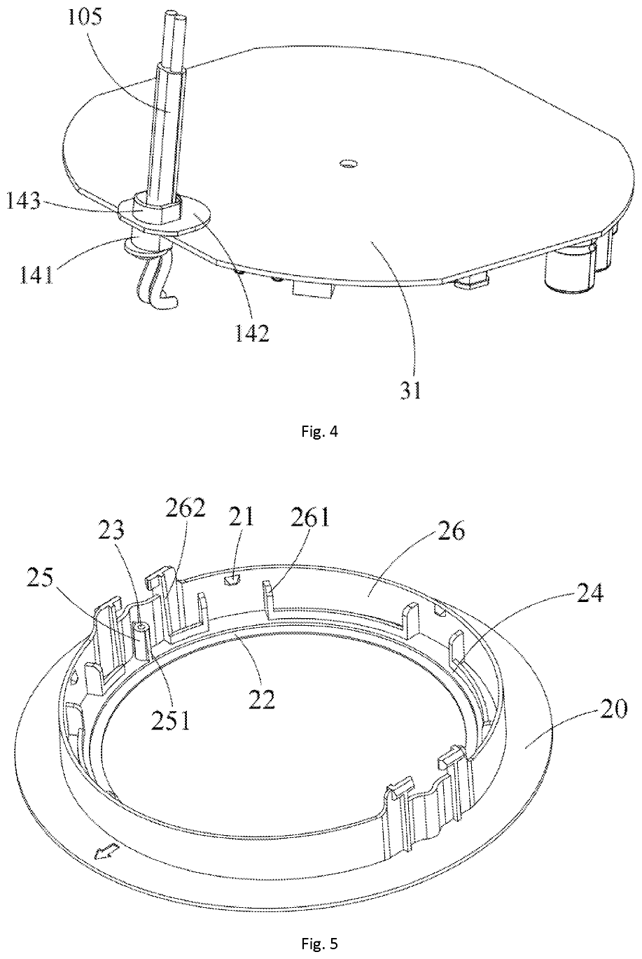

As shown in FIG. 3 and FIG. 4, a wire passing hole 14 is further formed on the housing 10. The wire passing hole 14 is arranged on the bottom wall 101 and located inside the annular groove 12. The lighting fixture 100 further includes an electric wire 105 and a cable gland 141 connected to the photoelectric assembly 30. One end of the cable gland 141 is connected to the photoelectric assembly 30, and the other end of the cable gland 141 penetrates the wire passing hole 14, so that the electric wire 105 extends to the outside of the housing 10 after passing through the cable gland 141 and the wire passing hole 14. Specifically, the cable gland 141 is provided with an extension section 142 and a protruding section 143. The extension section 142 is clamped between the bottom wall 101 and the substrate 31 and extends, along the surface of the annular groove 12, into the annular groove 12. The protruding section 143 is accommodated inside the wire passing hole 14 and configured to position the electric wire 105.

As shown in FIG. 2 and FIG. 5, a diffuser plate 50 is accommodated inside the trim ring 20 to further improve luminous efficiency. A buckle 21, a first abutting portion 22, a second abutting portion 24 and a second mounting hole 23 are arranged on the side of the trim ring 20 facing the housing 10. The first abutting portion 22 in an annular shape is arranged at the innermost side of the trim ring 20, and the diffuser plate 50 rests on the first abutting portion 22. The second abutting portion 24 is arranged on the outer periphery of the first abutting portion 22, and mounting posts 25 protruding toward the housing 10 are arranged on the second abutting portion 24. The second mounting hole 23 is formed on each mounting post 25, and positioning ribs 251 protruding toward the first abutting portion 22 are further arranged on the outer side walls of the mounting posts 25.

As shown in FIG. 2, FIG. 3 and FIG. 5, the trim ring 20 is assembled and fixed to the housing 10. Specifically, the trim ring 20 is further provided with an annular extension wall 26 protruding toward the housing 10. The buckle 21 is arranged on the extension wall 26, close to the top edge of the extension wall 26, i.e., close to the photoelectric assembly 30. A first positioning rib 261 and a second positioning rib 262 are further arranged on the extension wall 26. The first positioning rib 261 is spaced apart from the buckle 21 along the circumferential direction of the extension wall 26, and also spaced apart from the buckle 21 in the vertical direction. The second positioning rib 262 protrudes inward from the inner wall surface of the extension wall 26. A fixing edge 103 is arranged at the bottom edge of the housing 10, and a fixing hole 104 is formed on the fixing edge 103. During assembly of the housing 10 and the trim ring 20, the fixing edge 103 is limited between the buckle 21 and the first positioning rib 261, such that the buckle 21 and the first positioning rib 261 limit the housing 10 in the vertical direction; the second positioning rib 262 is accommodated inside the fixing hole 104 to limit the housing 10 in the circumferential direction. Furthermore, the housing 10 and the trim ring 20 are locked and connected by a second fastener 15 passing through a through hole 106 on the fixing edge 103 and a second mounting hole 23 on the mounting post 25. Preferably, the second fastener 15 is a screw, and the second mounting hole 23 is a threaded hole.

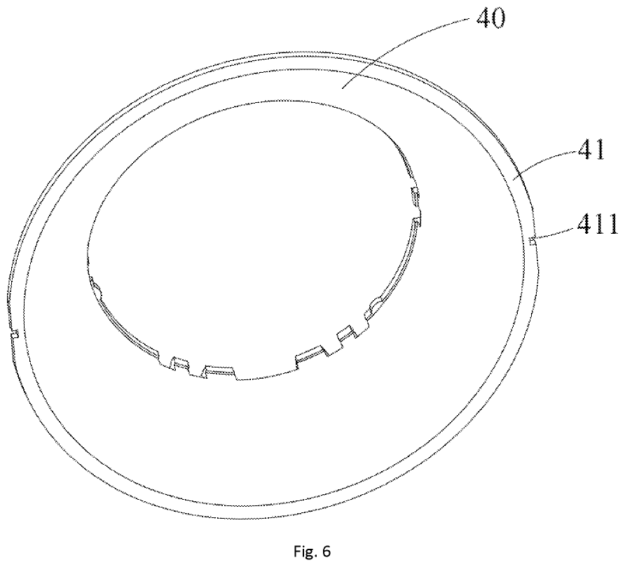

As shown in FIG. 2, FIG. 5 and FIG. 6, the reflector 40 is arranged between the photoelectric assembly 30 and the diffuser plate 50. The reflector 40 is trumpet-shaped with a reflective surface on its inner side, and the reflector 40 is provided with a light inlet and a light outlet. The light inlet abuts against the photoelectric assembly 30 such that the light source module 32 is positioned at an inner side of the light inlet, and the power supply module 33 is positioned at an outer side of the light inlet. In other words, the light inlet separates the light source module 32 from the power supply module 33, enabling the light source module 32 on the inner side to reflect light via the reflective surface.

The light outlet abuts against the trim ring 20. Specifically, an extension edge 41 is arranged on the side of the reflector 40 where the light outlet is located, and a positioning hole 411 corresponding to the positioning rib 251 is formed on the extension edge 41. When the reflector 40 abuts against the trim ring 20, the extension edge 41 is supported on the second abutting portion 24, and the positioning rib 251 is limited and accommodated inside the positioning hole 411, so as to realize circumferential positioning of the reflector 40.

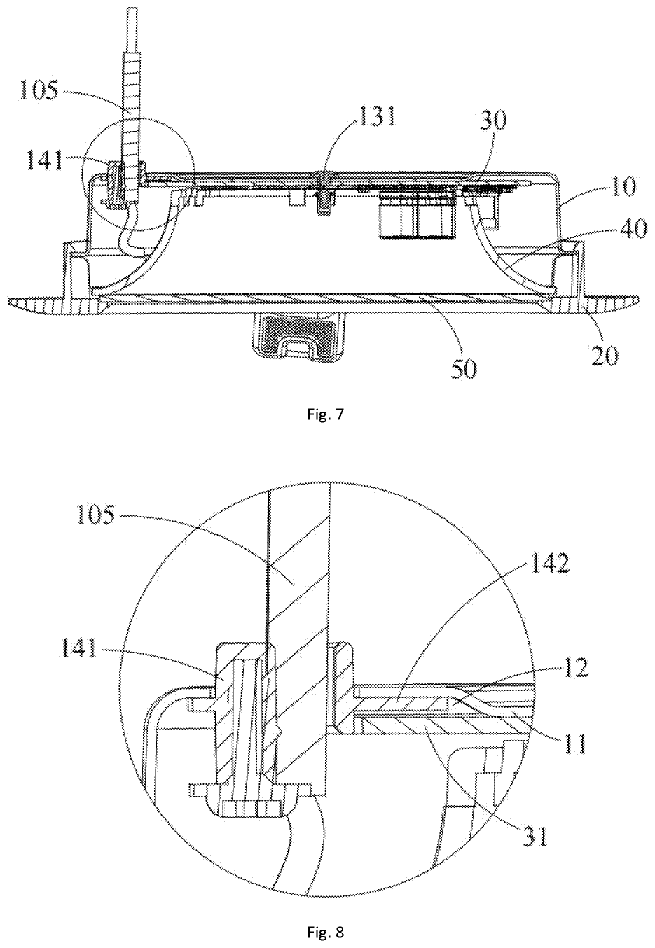

With reference to FIG. 7 and FIG. 8, the assembling process of the lighting fixture 100 of the present disclosure is as follows: first, placing the diffuser plate 50 inside the trim ring 20 such that the diffuser plate 50 rests on the first abutting portion 22, then placing the reflector 40 inside the trim ring 20 and fixing the reflector 40 onto the diffuser plate 50; next, passing the electric wire 105 connected to the photoelectric assembly 30 through the cable gland 141 and the wire passing hole 14 so that the electric wire 105 extends outside the housing 10, and that the cable gland 141 is fixed inside the wire passing hole 14; then, press-fitting the photoelectric assembly 30 onto the cable gland 141 and fixing the photoelectric assembly 30 to the housing 10 by passing the first fastener 131 through the first mounting hole 13, thus completing the assembly of the lamp body; finally, engaging the fully assembled lamp body with the housing 10 for fastening in a snap-fitting manner, thus completing the assembly of the lighting fixture 100.

In summary, according to the present disclosure, a boss 11 is arranged on the bottom wall 101 of the housing 10, and a part of the photoelectric assembly 30 abuts against the boss 11. As a result, the photoelectric assembly 30 can dissipate heat directly through the housing 10, which increases the overall heat dissipation area of the lighting fixture 100 and optimizes its heat dissipation condition. In addition, an annular groove 12 is formed between the boss 11 and the side walls 102 of the housing 10, and the power supply module 33 of the photoelectric assembly 30 overhangs below the annular groove 12, with a gap reserved between the power supply module 33 and the annular groove 12 in a vertical direction. This design enlarges the electrical distance and creepage distance between the housing 10 and the power supply module 33. The lighting fixture can therefore meet safety standard specifications while reducing its overall height, thereby effectively guaranteeing end users'operational safety.

An objective of the present disclosure is to provide a lighting fixture capable of enhancing heat dissipation performance while maintaining sufficient creepage distance.

To achieve the above objective, the present disclosure provides a lighting fixture, including a housing and a photoelectric assembly accommodated inside the housing. The housing is provided with a bottom wall facing the photoelectric assembly and side walls extending vertically downward from an outer peripheral edge of the bottom wall. A boss protruding toward the photoelectric assembly is arranged on the bottom wall, and an annular groove is formed between the boss and the side walls of the housing. When the photoelectric assembly is mounted inside the housing, a part of the photoelectric assembly abuts against the boss, and the other part of the photoelectric assembly extends to overhang outside the annular groove, with a gap reserved between the other part of the photoelectric assembly and the annular groove along an extension direction of the side walls.

As a further improvement of the present disclosure, a first mounting hole is formed on the boss, and the photoelectric assembly is fixed to the housing by a first fastener passing through the first mounting hole.

As a further improvement of the present disclosure, the photoelectric assembly includes a substrate, a light source module and a power supply module. Both the light source module and the power supply module are integrated on the substrate, and the power supply module is arranged to surround an outer side of the light source module.

As a further improvement of the present disclosure, an orthographic projection of the power supply module on the bottom wall of the housing overlaps with the annular groove, and an orthographic projection of the light source module on the bottom wall of the housing overlaps with the boss.

As a further improvement of the present disclosure, the lighting fixture further includes a trim ring arranged at an opening of the housing and fixedly assembled with the housing. A buckle and a second mounting hole are arranged on a side of the trim ring facing the housing. The buckle limits the housing in a vertical direction, and the housing is fixedly connected to the trim ring through a second fastener passing through the second mounting hole.

As a further improvement of the present disclosure, the lighting fixture further includes a diffuser plate accommodated within the trim ring. A first abutting portion in an annular shape is further provided on the side of the trim ring facing the housing, and the first abutting portion is located on an inner side of the second mounting hole. The diffuser plate rests on the first abutting portion.

As a further improvement of the present disclosure, the lighting fixture further includes a reflector provided with a light inlet and a light outlet. The light inlet abuts against the photoelectric assembly such that the light source module is positioned at an inner side of the light inlet and the power supply module is positioned at an outer side of the light inlet; the light outlet abuts against the trim ring.

As a further improvement of the present disclosure, a wire passing hole is formed on the housing. The lighting fixture further includes an electric wire and a cable gland connected to the photoelectric assembly. One end of the cable gland is connected to the photoelectric assembly, and the other end of the cable gland penetrates the wire passing hole, so that the electric wire extends to the outside of the housing after passing through the cable gland and the wire passing hole.

As a further improvement of the present disclosure, the wire passing hole is formed on the bottom wall and located inside the annular groove, and the cable gland penetrates the wire passing hole and partly extends into the annular groove.

As a further improvement of the present disclosure, the housing is a metal heat-dissipating housing.

The present disclosure may include dedicated hardware implementations such as disclosure specific integrated circuits, programmable logic arrays and other hardware devices. The hardware implementations can be constructed to implement one or more of the methods described herein. Examples that may include the apparatus and systems of various implementations can broadly include a variety of electronic and computing systems. One or more examples described herein may implement functions using two or more specific interconnected hardware modules or devices with related control and data signals that can be communicated between and through the modules, or as portions of an disclosure-specific integrated circuit. Accordingly, the system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

The above examples are merely intended to illustrate the technical solutions of the present disclosure rather than to limit it. Although the present disclosure has been described in detail with reference to examples, those skilled in the art should understand that modifications or equivalent substitutions may be made to the technical solutions of the present disclosure without departing from the spirit and scope of the technical solutions of the present disclosure.

1. A lighting fixture, comprising a housing and a photoelectric assembly accommodated inside the housing, wherein:
the housing is provided with a bottom wall facing the photoelectric assembly and side walls extending vertically downward from an outer peripheral edge of the bottom wall;
a boss protruding toward the photoelectric assembly is arranged on the bottom wall, and an annular groove is formed between the boss and the side walls of the housing; and
when the photoelectric assembly is mounted inside the housing, a part of the photoelectric assembly abuts against the boss, and the other part of the photoelectric assembly extends to overhang below the annular groove, with a gap reserved between the other part of the photoelectric assembly and the annular groove along an extension direction of the side walls.

2. The lighting fixture according to claim 1, wherein a first mounting hole is formed on the boss, and the photoelectric assembly is fixed to the housing by a first fastener passing through the first mounting hole.

3. The lighting fixture according to claim 1, wherein the photoelectric assembly comprises a substrate, a light source module and a power supply module; both the light source module and the power supply module are integrated on the substrate, and the power supply module is arranged to surround an outer side of the light source module.

4. The lighting fixture according to claim 3, wherein an orthographic projection of the power supply module on the bottom wall of the housing overlaps with the annular groove, and an orthographic projection of the light source module on the bottom wall of the housing overlaps with the boss.

5. The lighting fixture according to claim 3, further comprising a trim ring arranged at an opening of the housing and fixedly assembled with the housing, wherein a buckle and a second mounting hole are arranged on a side of the trim ring facing the housing, the buckle is configured to limit the housing in a vertical direction, and the housing is fixedly connected to the trim ring through a second fastener passing through the second mounting hole.

6. The lighting fixture according to claim 5, further comprising a diffuser plate accommodated within the trim ring, wherein a first abutting portion in an annular shape is further provided on the side of the trim ring facing the housing, the first abutting portion is located at an inner side of the second mounting hole, and the diffuser plate rests on the first abutting portion.

7. The lighting fixture according to claim 5, further comprising a reflector, wherein the reflector is provided with a light inlet and a light outlet, the light inlet abuts against the photoelectric assembly such that the light source module is positioned at an inner side of the light inlet and the power supply module is positioned at an outer side of the light inlet; and wherein the light outlet abuts against the trim ring.

8. The lighting fixture according to claim 1, wherein a wire passing hole is formed on the housing, and the lighting fixture further comprises an electric wire and a cable gland that are connected to the photoelectric assembly, one end of the cable gland is connected to the photoelectric assembly, and the other end of the cable gland penetrates the wire passing hole, so that the electric wire extends to an outside of the housing after passing through the cable gland and the wire passing hole.

9. The lighting fixture according to claim 8, wherein the wire passing hole is formed on the bottom wall and located inside the annular groove, and the cable gland penetrates the wire passing hole and partly extends into the annular groove.

10. The lighting fixture according to claim 1, wherein the housing is a metal heat-dissipating housing.

11. The lighting fixture according to claim 1, wherein the gap is greater than 1 mm.

12. The lighting fixture according to claim 3, wherein the substrate is formed of an FR-4 insulating material.
